(19) United States
(12) Patent Application Publication
(10) Pub. No.: US 2005/0103169 A1
(43) Pub. Date: May 19, 2005

(54) Wrench for firm engagement with fastener

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/987,538

(22) Filed: Nov. 12, 2004

(30) Foreign Application Priority Data
Nov. 18, 2003 (TW) 92132212

(51) Int. Cl. B25G 1/04

(52) U.S. Cl. 81/186

(57) ABSTRACT

A wrench includes a head. The head defines a space in order to receive an object. The wall of the space comprises a plurality of facets, a corner between any adjacent two of the facets and a restraint extending on each of the facets. Each of the restraints does not cover any of the corners.

### BACKGROUND OF INVENTION

1. Field of Invention

The present invention relates to a wrench for firm engagement with a fastener such as a bolt and a nut.

2. Related Prior Art

A spanner for preventing disengagement of fasteners is disclosed in US Patent Application Publication No. 2001/0054334 A1. The spanner includes a box end 11 in which a drive member 12 is rotationally installed. The drive member 12 includes an internal periphery for driving a fastener such as a nut 30 and a head of a bolt. The internal periphery of the drive member 12 includes six wall faces 13. That is, the internal periphery of the drive member 12 defines a hexagonal space 12a. A triangular groove 16 is defined in each wall face 13. Each triangular groove 16 includes a closed first end 161 and an open second end 162. The triangular grooves 16 together define a hexagonal space 16a different from the hexagonal space 12a by an angle of 30 degrees. The nut 30 can be put in the space 16a. The nut 30 abuts the closed ends 161 of the hexagonal space 16a in loosening or tightening. The nut 30 however often falls from the driver member 12 when it is to be engaged with the bolt or disengaged from the same.

In Taiwan Patent Publication No. 462317, a conventional wrench includes a handle 42 and a head 44 formed at an end of the handle 42. The head 44 includes an internal face with twelve corners 52 for receiving corners 62 of the head 60 of a bolt. Six restraints 54 are formed on the head 44 in order to restrain the head 60 of the bolt. Each restraint 54 is formed at an end of a corner 52. The restraints 54 are formed through pressing the head 44 and are therefore thin. The restraints 54 can be broken easily because they are thin.

The present invention is therefore intended to obviate or at least alleviate the problems encountered in prior art.

### SUMMARY OF INVENTION

According to the present invention, a wrench includes a head. The head defines a space in order to receive an object. The wall of the space comprises a plurality of facets, a corner between any adjacent two of the facets and a restraint extending on each of the facets. Each of the restraints does not cover any of the corners.

The primary advantage of the wrench of the present invention is that the restraints can firmly engage with the tool or fastener in order to avoid the tool or fastener escaping from the head in a direction.

Other objects, advantages and novel features of the invention will become more apparent from the following detailed description in conjunction with the attached drawings.

### BRIEF DESCRIPTION OF DRAWINGS

The present invention will be described via detailed illustration of the preferred embodiment referring to the drawings.

FIG. 1 is a perspective partial view of a wrench according to the preferred embodiment of the present invention.

FIG. 2 is a cut-away view of the wrench shown in FIG. 1.

FIG. 3 is a cross-sectional view of the wrench shown in FIG. 1.

FIG. 4 is a top view of a fastener firmly engaged with the wrench shown in FIG. 1.

### DETAILED DESCRIPTION OF PREFERRED EMBODIMENT

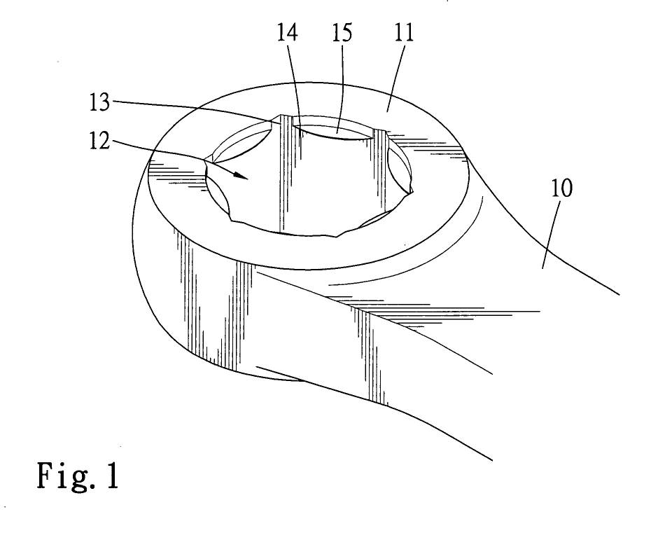

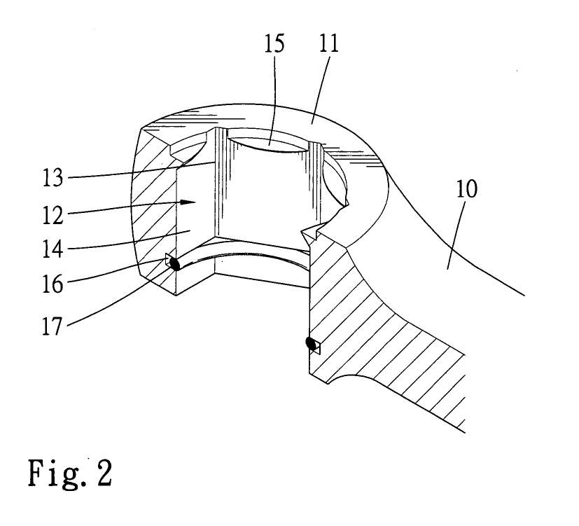

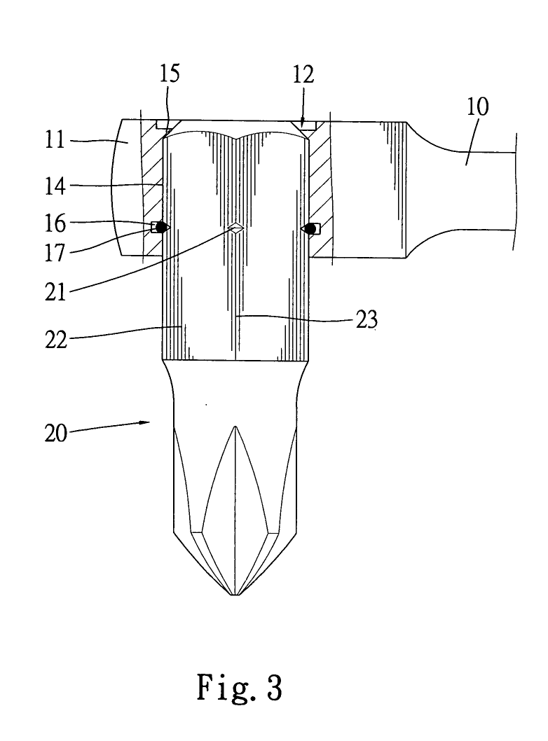

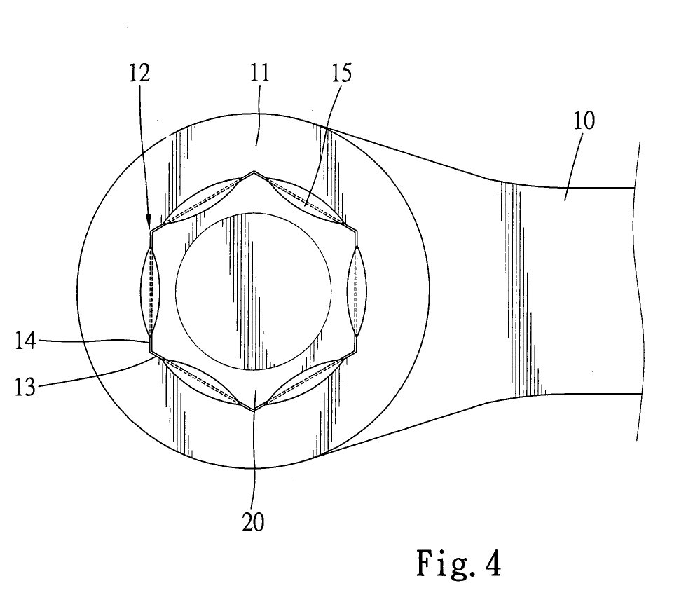

Referring to FIGS. 1 and 2, according to the preferred embodiment of the present invention, a wrench 10 includes a head 11 and a handle (not numbered) extending from the head 11. The head 11 defines a space 12 for receiving a fastener such as a nut and a bolt or a tool 20 such as a screwdriver (see FIGS. 3 and 4). The wall of the space 12 is polygonal, i.e., it consists of a plurality of facets 14. A corner 13 is defined between any two adjacent facets 14.

As best shown in FIG. 2, a restraint 15 is formed on each facet 14. The restraints 15 are formed on the facets 14 by means of punching. Each restraint 15 does not cover any corner 13. A groove 16 is defined in the wall of the space 12. A ring 17 is put in the groove 16. The ring 17 may be a C-ring or O-ring.

Referring to FIGS. 3 and 4, the tool 20, such as a screwdriver, includes a shank and a tip extending from the shank. The shank of the tool 20 includes a polygonal periphery consisting of a plurality of facets 22. An angle 23 is formed between any two adjacent facets 22. A recess 21 is defined in each angle 23.

In use, the shank of the tool 20 is put In the space 12. The shank of the tool 20 abuts the restraints 15. Thus, the shank of the tool 20 cannot escape from the head 11 in an upward direction. The abutment of the shank of the tool 20 against the restraints 15 is strong. The ring 17 is put in the recesses 21. Thus, the weight of the tool 20 alone cannot cause the tool 20 to escape from the head 11. Thus, the shank of the tool 20 is firmly engaged with the head 11 in, before or after operation.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A wrench comprising a head defining a space for receiving an object, wherein the wall of the space comprises a plurality of facets, a corner between any adjacent two of the facets and a restraint extending on each of the facets without covering any of the corners.

2. The wrench according to claim 1 wherein the restraint is formed on each of the facets by means of punching.

3. The wrench according to claim 1 wherein the restraint is located near an end of each of the facets.

4. The wrench according to claim 1 wherein the space is a hexagonal space.

5. The wrench according to claim 1 comprising a groove defined in the wall of the space and a ring put in the groove in order to hold the object.

6. The wrench according to claim 1 wherein the ring is a C-ring.

7. The wrench according to claim 1 wherein the ring is an O-ring.
